(19) United States
(12) Patent Application Publication
(10) Pub. No.: US 2009/0073311 A1
(43) Pub. Date: Mar. 19, 2009

(54) FRAME RATE CONVERSION DEVICE AND VIDEO DISPLAY DEVICE

(76) Inventors: Koichi Hamada, Kokubunji (JP); Yoshiaki Mizuhashi, Yokohama (JP); Mitsuo Nakajima, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/912,696

(22) PCT Filed: Apr. 28, 2005
(86) PCT No.: PCT/JP2005/008566

§ 371 Date: Oct. 26, 2007

(51) Int. Cl. H04N 7/01; H04N 5/66

(52) U.S. Cl. 348/441; 348/739; 348/E07.003; 348/E05.133

(57) ABSTRACT

A frame rate conversion device includes a signal input unit to which a video signal is inputted and a frame rate conversion unit for converting the frame number by inserting an interpolated frame into the video signal inputted to the signal input unit. The frame rate conversion unit performs block matching between a block contained in a frame preceding the interpolated frame and a block contained in a frame following the interpolated frame, thereby obtaining a motion vector of the interpolated pixel contained in the interpolated frame, and creates the interpolated pixel by using some pixels contained in the block subjected to the block matching when acquiring the motion vector.

### FIELD OF THE INVENTION

The invention relates to a frame rate conversion device provided in a video display device, and in particular, to a technology for converting a frame frequency of a video signal.

### BACKGROUND OF THE INVENTION

A video display device converts a frame frequency (frame rate) of a video signal received into a frame rate as desired to be then displayed. The video display device is provided with a frame rate conversion device for converting the frame rate.

A technology concerning the frame rate conversion device is disclosed in JP 2001-111968 A.

With the frame rate conversion device according to this technology, a frame rate of a video signal is increased by repeating the same frame image plural times.

For example, in the case of the frame rate conversion device increasing the frame rate of a video signal by a factor of two, each of frame images is repeated twice. In this case, an object moving on a screen of a video after conversion of the frame rate is seen at positions identical to each other, in two successive frame mages. Accordingly, there occurs a motion judder interference whereby smoothness of the video is impaired.

As a technology for solving this problem, there has been proposed a motion-compensation frame rate conversion method. The motion-compensation frame rate conversion method is disclosed in JP 1999-112939 A.

With a frame rate conversion device according to this technology, a motion vector is searched from a video signal before conversion of frame rate. Subsequently, respective positions of images contained in frame images before, and after the conversion of the frame rate are shifted according to the searched motion vector. Thus, a new frame image is generated. Then, the frame rate of the video signal is increased by inserting the new generated frame image.

The motion-compensation frame rate conversion method is effective for removal of the motion judder interference.

With the motion-compensation frame rate conversion, however, there occurs unique deterioration in picture quality. There is described herein the reason for occurrence of the deterioration in picture quality. The frame rate conversion device makes a search for one motion vector against one block by use of block matching. Then, a block in a new frame image is generated on the basis of the searched motion vector. For this reason, if a search result of the motion vector is even slightly erroneous, this will cause a noise in block-like form to occur to the new frame image.

Accordingly, there has been disclosed a technology for removing the noise in the block-like form in JP 1999-112939 A.

The frame rate conversion device according to this technology makes the search for the motion vector by use of the block matching, and subsequently, makes a search for a motion vector again on a pixel-by-pixel basis.

### SUMMARY OF THE INVENTION

With this frame rate conversion device, however, the search for the vector is executed twice. In consequence, the frame rate conversion device has had a problem of an increase in circuit scale and cost.

This invention has been developed in view of the problem described above, and it is therefore an object of the invention to provide a frame rate conversion device capable of keeping high picture quality at low cost.

According to one aspect of the invention, there is provided a frame rate conversion device comprising a signal input unit for receiving a video signal, and a frame rate conversion unit for converting the number of frames by inserting an interpolated frame into the video signal inputted to the signal input unit. The frame rate conversion unit obtains a motion vector of an interpolated pixel contained in the interpolated frame by performing block matching using a block contained in a frame preceding the interpolated frame, and a block contained in a frame following the interpolated frame, and generates the interpolated pixel by use of a portion of pixels contained in the respective blocks used in the block matching performed for obtaining the motion vector.

With the frame rate conversion device according to the invention, the frame rate can be converted at low cost while high picture quality is maintained.

### BRIEF DESCRIPTION OF THE DRAWINGS

FIG. 1 is a block diagram of a first embodiment of a frame rate conversion device in accordance with a first embodiment of this invention;

FIG. 2 is a flow chart showing an interpolated frame generation process executed by the frame rate conversion device in accordance with the first embodiment of this invention;

FIG. 3 is a schematic diagram illustrating a block-search process, and an interpolation target pixel generation process, executed by the frame rate conversion device in accordance with the first embodiment of this invention;

FIG. 4 is a schematic diagram illustrating blocks to be subjected to block matching performed by the frame rate conversion device in accordance with the first embodiment of this invention;

FIG. 5 is a schematic diagram illustrating a block-search process, and an interpolation target pixel generation process, executed by a frame rate conversion device in accordance with a second embodiment of this invention;

FIG. 6 is a schematic illustration of blocks to be subjected to block matching performed by a frame rate conversion device in accordance with a third embodiment of this invention;

FIG. 7 is a schematic illustration showing a block matching process executed by a frame rate conversion device in accordance with a fourth embodiment of this invention; and

FIG. 8 is a block diagram of a video display device in accordance with a fifth embodiment of this invention.

### DETAILED DESCRIPTION OF THE PREFERRED EMBODIMENT

### First Embodiment

A first embodiment of the invention describes the case of a frame rate of a video signal being converted so as to cause the frame rate doubled.

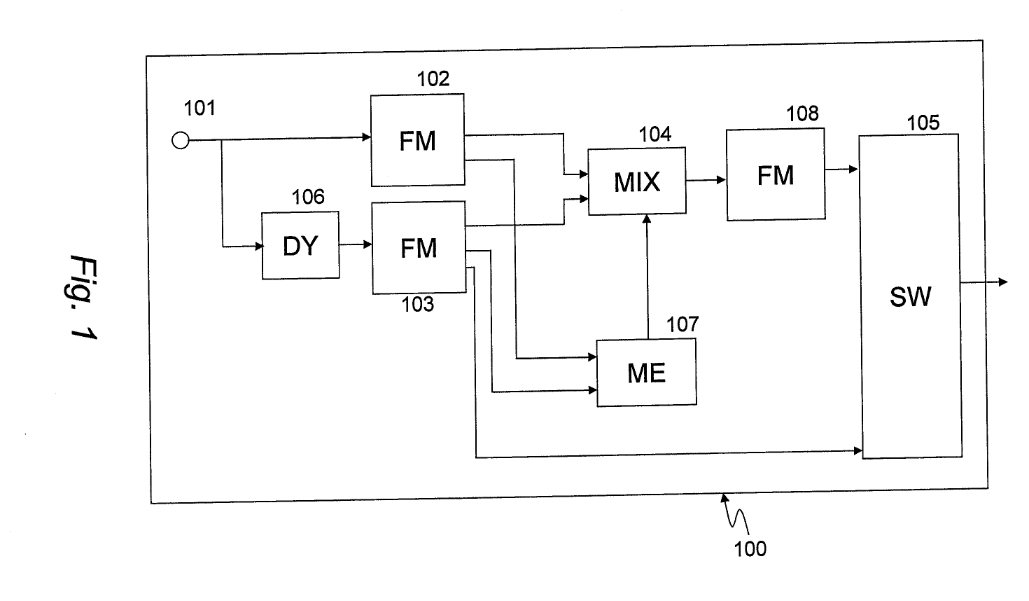

FIG. 1 is a block diagram of the first embodiment of a frame rate conversion device 100 according to the invention.

The frame rate conversion device 100 comprises a video input unit 101, image memories (FMs) 102, 103 and 108, a pixel interpolator (MIX) 104, a switching circuit (SW) 105, a delay unit (DY) 106, and a motion-search unit (ME) 107.

The video input unit 101 transmits a video signal inputted from outside to the image memory 102, and the delay unit 106.

The signal inputted to the video input unit 101 is a digital signal. Accordingly, the frame rate conversion device 100 is provided with an analog-to-digital (AD) converter if an analog signal is inputted thereto. The AD converter converts the analog signal inputted from outside into a digital signal, and transmits the digital signal converted to the video input unit 101.

The image memories 102, 103 and 108 each store a frame image of the video signal received. The delay unit 106 causes the video signal received to be delayed by a time length corresponding to one frame before transmitting the same to the image memory 103.

That is, the image memory 103 receives the video signal lagging by the one frame behind the video signal received by the image memory 102.

The motion-search unit 107 makes a search for a motion vector by performing block matching between the frame image stored by the image memory 102, and the frame image stored by the image memory 103. In other words, the motion-search unit 107 performs the block matching between a frame image, and another frame image that is caused to lag by one frame behind the frame image.

The pixel interpolator 104 generates an interpolated frame image on the basis of the frame images stored by the image memories 102, and 103, respectively, and the motion vector searched by the motion-search unit 107. Then, the pixel interpolator 104 transmits the generated interpolated frame image to the image memory 108.

The switching circuit 105 alternately outputs the interpolated frame image stored by the image memory 108, and the frame image stored by the image memory 103.

As described above, the frame rate conversion device 100 according to the invention, having those units and modules, is capable of converting the frame rate of the video signal so as to be doubled.

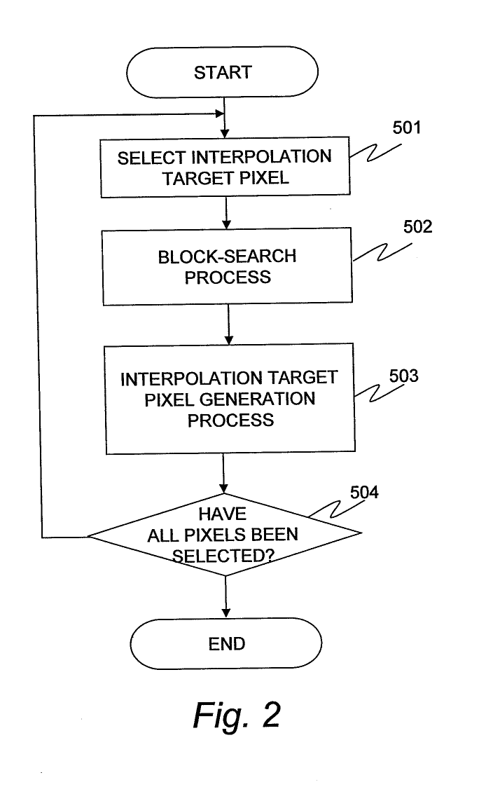

FIG. 2 is a flow chart showing an interpolated frame generation process executed by the frame rate conversion device 100 according to the first embodiment of the invention.

First, the motion-search unit 107 of the frame rate conversion device 100 selects one pixel (an interpolation target pixel) from the interpolated frame image in such a way as to select the whole interpolated frame image to be generated (501).

Then, the motion-search unit 107 of the frame rate conversion device 100 executes a block-search process against the selected interpolation target pixel (502).

Subsequently, the pixel interpolator 104 of the frame rate conversion device 100 executes an interpolation target pixel generation process on the basis of a block found by the motion-search unit 107 (503).

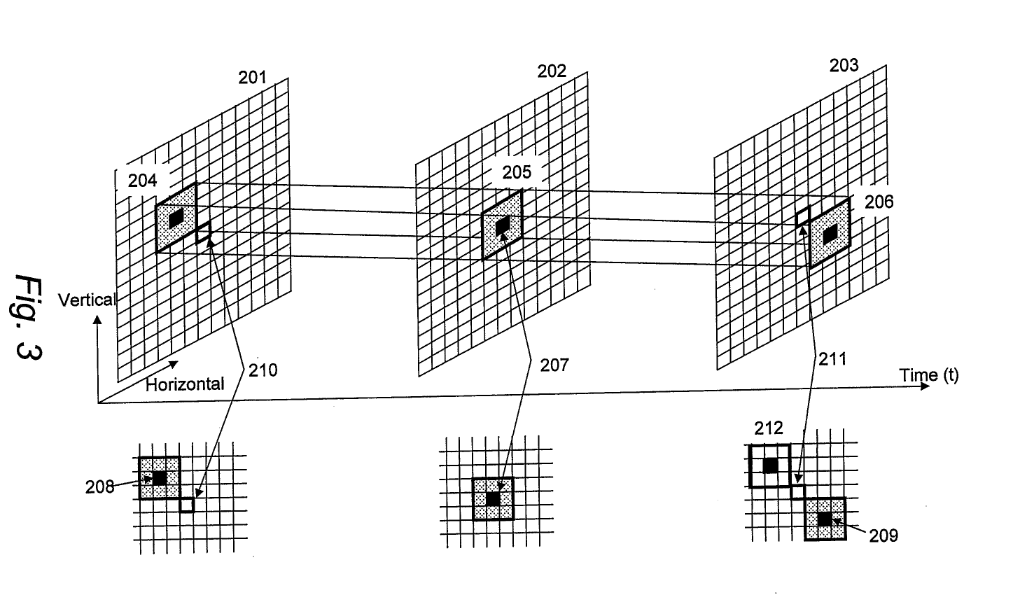

In this connection, the block-search process (502), and the interpolation target pixel generation process (503) will be described in detail later in the present description with reference to FIG. 3.

Next, the pixel interpolator 104 of the frame rate conversion device 100 determines whether or not the motion-search unit 107 has selected all the pixels contained in the interpolated frame image (504).

If the pixel interpolator 104 determines that not all the pixels have been selected, the process reverts to the step 501.

On the other hand, if he pixel interpolator 104 determines that all the pixels have been selected, the frame rate conversion device 100 determines that generation of the interpolated frame has been completed, thereby completing the process.

FIG. 3 is a schematic diagram illustrating the block-search process 502, and the interpolation target pixel generation process 503, executed by the frame rate conversion device 100 according to the first embodiment of the invention.

Herein, there is described the case where the frame rate conversion device 100 generates an interpolation target pixel 207 on an interpolated frame image 202. The frame rate conversion device 100 generates the interpolated frame image 202 from a frame image (pre-frame image) 201 immediately preceding the interpolated frame image 202 to be generated, and a frame image (post-frame image) 203 immediately following the interpolated frame image 202 to be generated.

In the schematic diagram, the pre-frame image 201, the interpolated frame image 202, and the post-frame image 203 are disposed in such a way as to correspond to time, respectively. Accordingly, time between the pre-frame image 201 and the interpolated frame image 202 is same as time between the interpolated frame image 202, and the post-frame image 203.

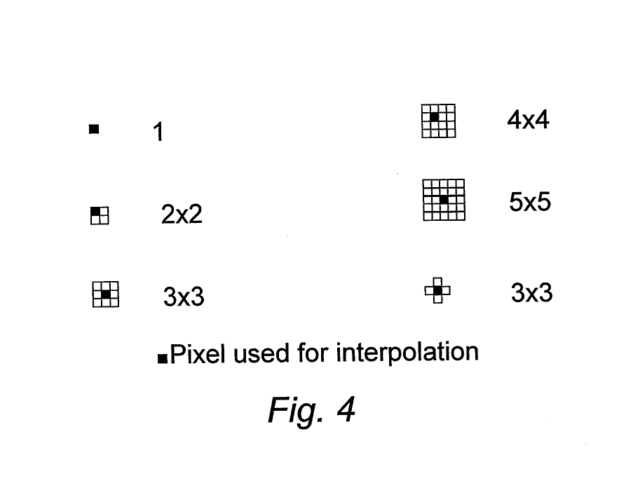

First, the frame rate conversion device 100 selects a block 205 containing the interpolation target pixel 207. In the schematic diagram, the block 205 is in the shape of a 3×3 block centering around the interpolation target pixel 207. Further, the block 205 may be in any shape, and any size as long as the same contains the interpolation target pixel 207. The block 205 will be described later with reference to FIG. 4.

Subsequently, the frame rate conversion device 100 obtains a shift direction (a motion vector) of the block 205, in an interval between the pre-frame image 201, and the post-frame image 203, by use of the block matching method.

More specifically, the frame rate conversion device 100 identifies a pixel 210 at a position identical to that of the interpolation target pixel 207 of the interpolated frame image 202 from the pre-frame image 201. The frame rate conversion device 100 similarly identifies a pixel 211 at a position identical to that of the interpolation target pixel 207 of the interpolated frame image 202 from the post-frame image 202.

Then, a search block 204 identical in size to the block 205 is caused to shift in such a way as to select a search range in whole within the pre-frame image 201. The search range may be the pre-frame image 201 in whole, however, a predetermined range centering around the identified pixel 210 can be adopted as the search range in consideration of computational complexity.

Subsequently, the following process is applied to the search block 204 at respective shifted positions thereof.

First, the frame rate conversion device 100 identifies a block 212 at a position identical to that of the search block 204 of the pre-frame image 201 from the post-frame image 203. Then, the frame rate conversion device 100 identifies a search block 206 that is point-symmetric against the identified block 212 with respect to the pixel 211 of the post-frame image 203, from the post-frame image 203.

Subsequently, a correlation value of the search block 204 of the pre-frame image 201, and the search block 206 of the post-frame image 203 is obtained. The correlation value is obtained by a method using the sum (SAD) of the absolute values of a difference between pixel values of pixels positionally corresponding to each other, or the sum of the squares of the difference between the pixel values of the pixels positionally corresponding to each other, and so forth.

Thus, the frame rate conversion device 100 obtains the correlation value of the search block 204 of the pre-frame image 201, and the search block 206 of the post-frame image 203, at all the shifted positions of the search block 204.

The frame rate conversion device 100 thereby makes a search for the combination of the blocks (the combination of the search block 204 of the pre-frame image 201, and the search block 206 of the post-frame image 203) with the obtained highest correlation value.

As the correlation value of the combination of the blocks searched is high, the frame rate conversion device 100 determines that shifting has occurred from the search block 204 of the combination to the search block 206 of the combination. By searching using the combination of the blocks at respective positions that are point-symmetric with respect to the interpolation target pixel, it becomes possible to make an efficient search for only the motion vector of the interpolation target pixel.

Accordingly, using a portion of the pixels contained in the search blocks 204 and 206, respectively, the frame rate conversion device 100 obtains a pixel value of the interpolation target pixel 207 contained in the interpolated frame image 202 positioned at the midpoint between the pre-frame image 201, and the post-frame image 203.

More specifically, a pixel 208 at a position identical to that of the interpolation target pixel 207, in the block 205, is selected from the search block 204 of the pre-frame image 201. Similarly, a pixel 209 at a position identical to that of the interpolation target pixel 207, in the block 205, is selected from the search block 206 of the post-frame image 203. With the present embodiment, the pixel 208 at the center of the search block 204, and the pixel 209 at the center of the search block 206 are selected.

Subsequently, the frame rate conversion device 100 obtains a pixel value P of the pixel 208 selected from the search block 204 of the pre-frame image 201, and a pixel value N of the pixel 209 selected from the search block 206 of the post-frame image 203.

Then, on the basis of the obtained pixel values P and N, a pixel value X of the interpolation target pixel 207 of the interpolated frame image 202 is calculated.

The pixel value X of the interpolation target pixel 207 of the interpolated frame image 202 is calculated by, for example, the following expression (1).

X=(P+N)/2 (1)

Further, for the pixel value X of the interpolation target pixel 207, either the obtained pixel value P or the obtained pixel value N may be adopted as it is. The reason is that since the correlation value of the search block 204 of the pre-frame image 201, and the search block 206 of the post-frame image 203 is high, the pixel value P of the pixel 208 contained in the search block 204, and the pixel value N of the pixel 209 contained in the search block 206 will be approximate to each other. In such a case, with the frame rate conversion device 100, it is possible to reduce computational complexity, circuit scale, and so forth.

FIG. 4 is a schematic diagram illustrating blocks to be subjected to the block matching performed by the frame rate conversion device 100 according to the first embodiment of the invention.

The schematic illustration shows blocks in various sizes. A pixel colored in black indicates the interpolation target pixel.

The block may be in any block provided that the same contains the interpolation target pixel.

The block may be either the interpolation target pixel itself, or lager in size than the interpolation target pixel. The block is in the shape of, for example, a square, rectangle, or cross.

Further, the block may be in the shape of an 8×8 block, or a 16×16 block for use in MPEG-2 coding, and so forth.

The larger the shape of the block, the higher the precision of the block matching performed by the frame rate conversion device 100 will be. However, if the shape of the block becomes larger, this will cause an increase in computational complexity of the frame rate conversion device 100. Accordingly, the shape of the block is decided on in consideration of those points.

With the frame rate conversion device 100 according to the present embodiment, the block matching is performed by use of the block larger in size than the interpolation target pixel to thereby make a search using information on a wide region, and consequently, errors in the search for the motion vector can be decreased. Meanwhile, since interpolation is executed by use of the portion of the pixels in the block used in the search for the motion, it is possible to lessen the risk of the interpolation being executed with a wrong pixel in the wide region in case an error is made in the search for the motion, thereby enabling erroneous interpolation on account of the motion vector to become inconspicuous.

### Second Embodiment

With a frame rate conversion device 100 according to a second embodiment of the invention, a frame rate of a video signal is converted to increase by a multiplying factor other than two.

The frame rate conversion device 100 according to the second embodiment of the invention is the same in makeup as the frame rate conversion device 100 (FIG. 1) according to the first embodiment of the invention. Further, the frame rate conversion device 100 according to the second embodiment executes the same process as that (FIG. 2) executed by the frame rate conversion device 100 according to the first embodiment, except for the block-search process 502, and the interpolation target pixel generation process 503. Description of the same makeup, and the same process is therefore omitted.

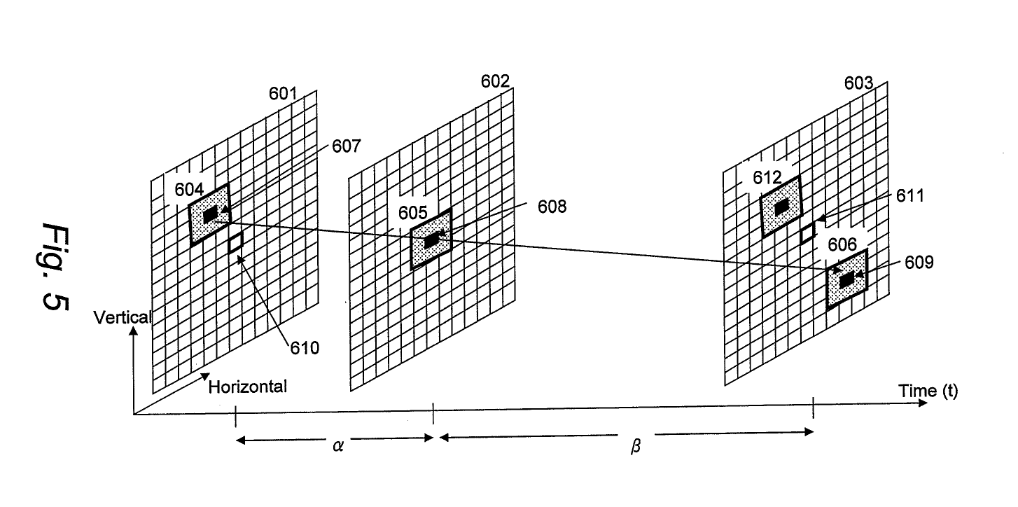

FIG. 5 is a schematic diagram illustrating a block-search process (502), and an interpolation target pixel generation process (503), executed by the frame rate conversion device 100 according to the second embodiment of the invention.

Herein, there is described the case where the frame rate conversion device 100 generates an interpolation target pixel 608 on an interpolated frame image 602. The frame rate conversion device 100 generates the interpolated frame image 602 from a frame image (pre-frame image) 601 immediately preceding the interpolated frame image 602 to be generated, and a frame image (post-frame image) 603 immediately following the interpolated frame image 602 to be generated.

In the schematic diagram, the pre-frame image 601, the interpolated frame image 602, and the post-frame image 603 are disposed in such a way as to correspond to time, respectively. Accordingly, a ratio of time between the pre-frame image 601, and the interpolated frame image 602 to time between the interpolated frame image 602, and the post-frame image 603 is α:β.

First, the frame rate conversion device 100 selects a block 605 containing the interpolation target pixel 608. In the schematic diagram, the block 605 is in the shape of a 3×3 block centering around the interpolation target pixel 608. Further, the block 605 may be in any shape if the interpolation target pixel 608 is contained therein.

Subsequently, the frame rate conversion device 100 obtains a shift direction (a motion vector) of the block 605, in an interval between the pre-frame image 601, and the post-frame image 603, using the block matching method.

More specifically, the frame rate conversion device 100 identifies a pixel 610 at a position identical to that of the interpolation target pixel 608 of the interpolated frame image 602, from the pre-frame image 601. The frame rate conversion device 100 similarly identifies a pixel 611 at a position identical to that of the interpolation target pixel 608 of the interpolated frame image 602, from the post-frame image 603.

Then, a search block 604 identical in size to the block 605 is caused to shift in such a way as to select a search range in whole within the pre-frame image 601. The search range may be the pre-frame image 601 in whole, or a predetermined range centering around the identified pixel 610.

Subsequently, the following process is applied to the search block 604 at respective shifted positions thereof.

First, the frame rate conversion device 100 identifies a block 612 at a position identical to that of the search block 604 of the pre-frame image 601, from the post-frame image 603. Then, the frame rate conversion device 100 obtains a distance between the center of the identified block 612 and the identified pixel 611. Subsequently, the obtained distance is multiplied by β/α.

Subsequently, the frame rate conversion device 100 identifies a pixel 609 on a straight line interconnecting the center of the identified block 612 and the identified pixel 611. The identified pixel 609 is assumed apart from the pixel 611 by a distance obtained by multiplying the distance between the center of the block 612 and the pixel 611 by β/α.

The frame rate conversion device 100 identifies a search block 606 containing the identified pixel 609, identical in size to the block 605, from the post-frame image 603.

Subsequently, a correlation value of the search block 604 of the pre-frame image 601, and the search block 606 of the post-frame image 603 is obtained.

Thus, the frame rate conversion device 100 obtains the correlation value of the search block 604 of the pre-frame image 601, and the search block 606 of the post-frame image 603, at all shifted positions of the search block 604.

Then, the frame rate conversion device 100 makes a search for the combination of the blocks (the combination of the search block 604 of the pre-frame image 601, and the search block 606 of the post-frame image 603) with the obtained highest correlation value.

As the correlation value of the combination of the blocks searched is high, the frame rate conversion device 100 determines that shifting has occurred from the search block 604 of the combination to the search block 606 of the combination.

Accordingly, using pixels contained in the search blocks 604, 606, respectively, the frame rate conversion device 100 obtains a pixel value of the interpolation target pixel 608 contained in the interpolated frame image 602 positioned at the midpoint between the pre-frame image 601, and the post-frame image 603.

More specifically, a pixel 607 at a position identical to that of the interpolation target pixel 608, in the block 605, is selected from the search block 604 of the pre-frame image 601. Similarly, a pixel 609 at a position identical to that of the interpolation target pixel 608, in the block 605, is selected from the search block 606 of the post-frame image 603. With the present embodiment, the pixel 607 at the center of the search block 604, and the pixel 609 at the center of the search block 606 are selected.

Subsequently, the frame rate conversion device 100 obtains a pixel value P2 of the pixel 607 selected from the search block 604 of the pre-frame image 601, and a pixel value N2 of the pixel 609 selected from the search block 606 of the post-frame image 603.

In this connection, depending on respective values of α and β, the pixel 609 selected from the search block 606 will be at a position where no pixel can exist in reality. In such a case, the frame rate conversion device 100 obtains the pixel value N2 of the pixel 609 on the basis of a weighted average of pixel values of pixels surrounding the pixel 609.

Then, on the basis of the obtained pixel values P2 and N2, a pixel value X of the interpolation target pixel 608 of the interpolated frame image 602 is calculated.

The pixel value X2 of the interpolation target pixel 608 of the interpolated frame image 602 is calculated by, for example, the following expression (2).

X2=(α×N2+β×P2)/(α+β) (2)

Further, either the obtained pixel value P2 or the obtained pixel value N2 may be adopted as it is for the pixel value X2 of the interpolation target pixel 608.

As described above, the frame rate conversion device 100 generates the interpolation target pixel 608 of the interpolated frame image 602.

With the frame rate conversion device 100 according to the present embodiment, a frame rate of the video signal can be converted to increase by an optional multiplying factor.

### Third Embodiment

With a frame rate conversion device 100 according to a third embodiment of the invention, plural pixels en bloc are interpolated.

The frame rate conversion device 100 according to the third embodiment of the invention is the same in makeup as the frame rate conversion device 100 (FIG. 1) according to the first embodiment of the invention. Further, the frame rate conversion device 100 according to the third embodiment selects plural interpolation target pixels in the step 501 of processing. The frame rate conversion device 100 according to the third embodiment executes the same process as that (FIG. 2) by the frame rate conversion device 100 according to the first embodiment, except for the processing in the step 501. Description of the same makeup, and the same process is therefore omitted.

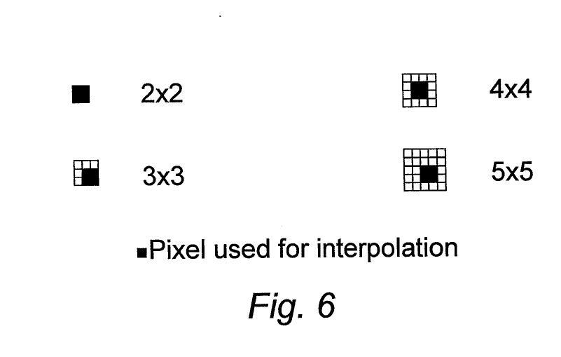

FIG. 6 is a schematic illustration of blocks to be subjected to block matching performed by the frame rate conversion device 100 according to the third embodiment of the invention.

The schematic illustration shows blocks in various sizes. A pixel colored in black indicates an interpolation target pixel.

With the frame rate conversion device 100 according to the first embodiment of the invention, the interpolation target pixel is interpolated one by one. With the frame rate conversion device 100 according to the present embodiment, however, plural the interpolation target pixels en bloc are interpolated. The present schematic illustration shows the case where 2×2 of the interpolation target pixels en bloc are interpolated.

Since the frame rate conversion device 100 according to the present embodiment interpolates the plurality of the interpolation target pixels en bloc, it is possible to ease an interpolated frame image generation process. Particularly, when a screen size of a display device for displaying a video is large, the frame rate conversion device 100 according to the present embodiment is effective. That is because even a 2×2 block noise will become inconspicuous if the screen size of the display device is large.

Further, the frame rate conversion device 100 may decide the number of the interpolation target pixels to be interpolated at a time according to the screen size of the display device.

Furthermore, it is preferable for the frame rate conversion device 100 to make a search for a motion vector by use of the blocks as large as possible. The reason for that is because the frame rate conversion device 100 can reduce errors in a search for the motion vector by using large blocks in searching.

Still further, it is preferable that the number of the interpolation target pixels to be interpolated by the frame rate conversion device 100 at a time is as few as possible. That is because erroneous interpolation will be inconspicuous by so doing in case a wrong motion vector is searched

### Fourth Embodiment

A frame rate conversion device 100 according to a fourth embodiment of the invention performs block matching by use of four frame images.

The frame rate conversion device 100 according to the fourth embodiment of the invention is the same in makeup as the frame rate conversion device 100 (FIG. 1) according to the first embodiment of the invention. Further, the frame rate conversion device 100 according to the fourth embodiment executes a block-search process by use of the four frame images in the step 502.

The frame rate conversion device 100 according to the fourth embodiment executes the same processing as that (FIG. 2) by the frame rate conversion device 100 according to the first embodiment, except for the process in the step 502. Description of the same makeup, and the same process is therefore omitted.

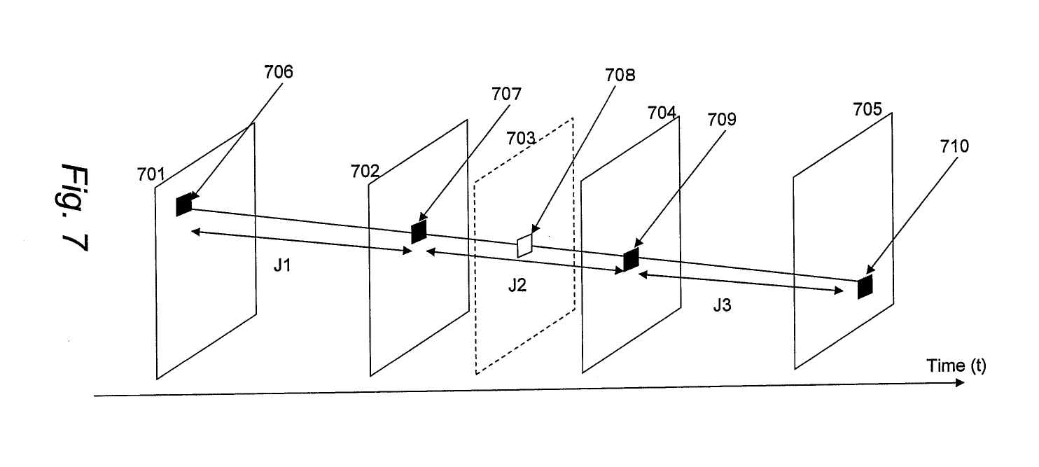

FIG. 7 is a schematic illustration showing a block matching process executed by the frame rate conversion device 100 according to the fourth embodiment of the invention.

Herein, there is described the case where the frame rate conversion device 100 generates an interpolation target pixel on an interpolated frame image 703. The frame rate conversion device 100 generates the interpolated frame image 703 from two pre-frame images 701 and 702, and two post-frame images 704 and 705.

In the schematic illustration, the pre-frame images 701 and 702, the interpolated frame image 703, and the post-frame images 704 and 705 are disposed in such a way as to correspond to time, respectively. With the frame rate conversion device 100 according to the first embodiment, one delay unit (DY) is used to thereby have two frames including the pre-frame image, and the post-frame image, generated on the image memories (FMs), respectively. With the present embodiment, in order to make up the interpolated frame by use of, for example, four frames, three delay units (DYs) are used to thereby have four images generated on the image memories (FMs), respectively.

The frame rate conversion device 100 according to the first embodiment performs the block matching by use of two frame images including the pre-frame image, and the post-frame image. The frame rate conversion device 100 according to the present embodiment, however, performs block matching by use of the four frame images including the two pre-frame images 701 and 702, and the two post-frame images 704 and 705.

The frame rate conversion device 100 selects a block 708 containing the interpolation target pixel from the interpolated frame image 703.

Subsequently, the frame rate conversion device 100 obtains a shift direction (a motion vector) of a block 707, in an interval between the pre-frame image 701, and the post-frame image 705 by performing the block matching using the pre-frame images 701 and 702, and the post-frame images 704 and 705.

More specifically, the frame rate conversion device 100 obtains a correlation value J1 of a search block 706 of the pre-frame image 701, and the search block 707 of the pre-frame image 702. Similarly, a correlation value J2 of the search block 707 of the pre-frame image 702, and a search block 709 of the post-frame image 704 is obtained. Further, a correlation value J3 of the search block 709 of the post-frame image 704, and a search block 710 of the post-frame image 705 is obtained. The frame rate conversion device 100 obtains the respective correlation values by the method described with reference to the first embodiment.

The frame rate conversion device 100 makes a search for the combination of the search blocks (the combination of the search blocks 706, 707, 709 and 710) with the sum of the obtained respective correlation values J1, J2 and J3, being at the smallest value.

Then, the frame rate conversion device 100 obtains a pixel value of the interpolation target pixel of the interpolated frame image 703 by use of pixels contained in the search blocks 706, 707, 709 and 710, respectively.

More specifically, the frame rate conversion device 100 obtains the pixel value of the interpolation target pixel of the interpolated frame image 703 by averaging pixel values of the pixels contained in the search blocks 706, 707, 709 and 710, respectively. Otherwise, the frame rate conversion device 100 may adopt the pixel value of the pixel contained in the search block 707 of the pre-frame image 702, or the search block 709 of the post-frame image 704, as it is, for the pixel value of the interpolation target pixel.

With the frame rate conversion device 100, any number of the frame images may be used at the time of generating the interpolated frame image 708 provided that the number thereof is two or more.

With the frame rate conversion device 100 according to the present embodiment, the block matching is performed by use of a multitude of the frame images, so that erroneous interpolation can be reduced.

### Fifth Embodiment

A fifth embodiment of the invention represents the case where the frame rate conversion device 100 according to the present invention is applied to a video display device such a TV, and so forth.

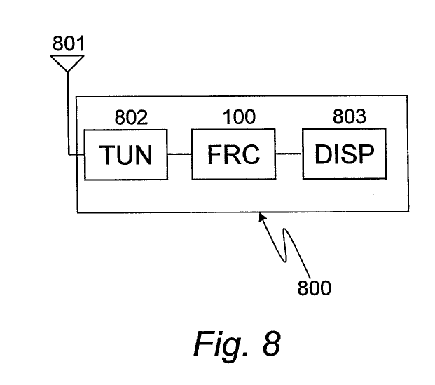

FIG. 8 is a block diagram of a video display device 800 according to the fifth embodiment of the invention.

The video display device 800 comprises an antenna 801, a receiver unit (TUN) 802, the frame rate conversion device (FRC) 100, and a display unit (DISP) 803.

The antenna 801 receives radio waves from outside, and sends out the received radio waves to the receiver unit 802. The receiver unit 802 converts the radio wave received from the antenna 801 into a digital signal, and sends out the converted video signal to the frame rate conversion device 100.

The frame rate conversion device 100 converts a frame rate of the video signal received from the receiver unit, and sends out the video signal to the display unit 803. The frame rate conversion device 100 may be one according to any of the first to fourth embodiments of the invention.

The display unit 803 displays the video signal received from the frame rate conversion device 100. Since the video signal is converted so as to have a frame rate suitable for the display unit 803 using the frame rate conversion device 100 according to the invention, the video display device 800 is able to display smooth images.

### INDUSTRIAL APPLICABILITY

The present invention converts the frame rate of the video signal, and is therefore suitable for use in a video display device such a TV, and so forth.

What is claimed is:

1. A frame rate conversion device comprising:
a signal input unit for receiving a video signal; and
a frame rate conversion unit for converting the number of frames by inserting an interpolated frame into the video signal inputted to the signal input unit,
wherein the frame rate conversion unit is configured to:
obtain a motion vector of an interpolated pixel contained in the interpolated frame by performing block matching using a block contained in a frame preceding the interpolated frame and a block contained in a frame following the interpolated frame; and
generate the interpolated pixel by using a portion of pixels contained in the respective blocks used in the block matching performed for obtaining the motion vector.

2. The frame rate conversion device according to claim 1, wherein the frame rate conversion unit is further configured to:
select blocks at respective positions that are mutually point-symmetric with respect to the interpolated pixel from the frame preceding the interpolated frame, and the frame following the interpolated frame; and
obtain the motion vector of the interpolated pixel contained in the interpolated frame by performing block matching using the selected blocks.

3. The frame rate conversion device according to claim 1, wherein the frame rate conversion unit is further configured to obtain the motion vectors of all the interpolated pixels contained in the interpolated frame respectively.

4. The frame rate conversion device according to claim 1,
wherein the block contains a plurality of the pixels, and
wherein the frame rate conversion unit is further configured to generate the interpolated pixel by using one of the pixels contained in the blocks used in the block matching performed for obtaining the motion vector.

5. The frame rate conversion device according to claim 1,
wherein the block contains a plurality of the pixels, and
wherein the frame rate conversion unit is further configured to generate the interpolated pixel by using not less than two of the pixels contained in the blocks used in the block matching performed for obtaining the motion vector.

6. The frame rate conversion device according to claim 1, wherein the frame rate conversion unit is further configured to obtain the motion vector of the interpolated pixel contained in the interpolated frame by performing block matching using a plurality of frames preceding the interpolated frame and a plurality of frames following the interpolated frame.

7. A video display device comprising:
a signal input unit for receiving a video signal;
a frame rate conversion unit for converting the number of frames by inserting an interpolated frame into the video signal inputted to the signal input unit, and
a display unit for displaying the video signal with the number of frames converted by the frame rate conversion unit,
wherein the frame rate conversion unit is configured to:
obtain a motion vector of an interpolated pixel contained in the interpolated frame by performing block matching using a block contained in a frame preceding the interpolated frame and a block contained in a frame following the interpolated frame; and
generate the interpolated pixel by use of a portion of pixels contained in the respective blocks used in the block matching performed for obtaining the motion vector.

8. The video display device according to claim 7, wherein the frame rate conversion unit is further configured to:
select blocks at respective positions that are mutually point-symmetric with respect to the interpolated pixel from the frame preceding the interpolated frame, and the frame following the interpolated frame; and
obtain the motion vector of the interpolated pixel contained in the interpolated frame by performing block matching using the selected blocks.

9. The video display device according to claim 7, wherein the frame rate conversion unit is further configured to obtain the motion vectors of all the interpolated pixels contained in the interpolated frame respectively.

10. The video display device according to claim 7,
wherein the block contains a plurality of the pixels, and
wherein the frame rate conversion unit is further configured to generate the interpolated pixel by using one of the pixels contained in the blocks used in the block matching performed for obtaining the motion vector.

11. The video display device according to claim 7,
wherein the block contains a plurality of the pixels, and
wherein the frame rate conversion unit is further configured to generate the interpolated pixel by use of not less than two of the pixels contained in the respective blocks used in the block matching performed for obtaining the motion vector.

12. The video display device according to claim 7, wherein the frame rate conversion unit is further configured to obtain the motion vector of the interpolated pixel contained in the interpolated frame by performing block matching using a plurality of frames preceding the interpolated frame and a plurality of frames following the interpolated frame.
